(19) United States
(12) Patent Application Publication
(10) Pub. No.: US 2023/0164499 A1
(43) Pub. Date: May 25, 2023

(54) PINNAL DEVICE

(71) Applicant: Cochlear Limited, Macquarie University, NSW (AU)

(72) Inventors: Milind RAJE, Glenwood, NSW (AU); Rishi WADHWANI, North Ryde, NSW (AU)

(21) Appl. No.: 17/920,153

(22) PCT Filed: Mar. 30, 2021
(86) PCT No.: PCT/IB2021/052636

§ 371 Date: Oct. 20, 2022

Related U.S. Application Data
(60) Provisional application No. 63/015,881, filed on Apr. 27, 2020.

(51) Int. Cl. H04R 25/00; H04R 25/02

(52) U.S. Cl. CPC H04R 25/604; H04R 25/02; H04R 25/603; H04R 25/652; H04R 2225/025; H04R 2460/09; H04R 2460/13

(57) ABSTRACT

Disclosed examples include devices that are wearable at a recipient’s pinna and configured to deliver bone-conduction vibrations directly to the pinna. The device can be so configured by having a vibration transfer surface disposed within the pinna when the device is worn. The devices can lack a component configured to deliver vibrations to a non-pinnal surface, such as the ear canal. The devices can include a projection configured to be disposed within a recipient’s ear canal that is vibrationally decoupled from the remainder of the device.

### BACKGROUND

### Field of the Invention

The present invention relates generally to ear-worn devices.

### Related Art

Medical devices have provided a wide range of therapeutic benefits to recipients over recent decades. Medical devices can include internal or implantable components/devices, external or wearable components/devices, or combinations thereof (e.g., a device having an external component communicating with an implantable component). Medical devices, such as traditional hearing aids, partially or fully-implantable hearing prostheses (e.g., bone conduction devices, mechanical stimulators, cochlear implants, etc.), pacemakers, defibrillators, functional electrical stimulation devices, and other medical devices, have been successful in performing lifesaving and/or lifestyle enhancement functions and/or recipient monitoring for a number of years.

The types of medical devices and the ranges of functions performed thereby have increased over the years. For example, many medical devices, sometimes referred to as “implantable medical devices,” now often include one or more instruments, apparatus, sensors, processors, controllers or other functional mechanical or electrical components that are permanently or temporarily implanted in a recipient. These functional devices are typically used to diagnose, prevent, monitor, treat, or manage a disease/injury or symptom thereof, or to investigate, replace or modify the anatomy or a physiological process. Many of these functional devices utilize power and/or data received from external devices that are part of, or operate in conjunction with, implantable components.

### SUMMARY

In a first example, there is an apparatus comprising: a bone conduction actuator configured to conduct vibrations directly to a surface of a pinna when the apparatus is worn by a recipient, wherein the apparatus lacks a component configured to deliver vibrations to a non-pinnal surface.

In a second example, there is a system comprising: a bone conduction device having: a bone conduction actuator; and a single vibration transfer surface, wherein the vibration transfer surface is configured to conduct vibrations from the bone conduction actuator to a point of contact within a pinna when the bone conduction device is worn at least partially within the pinna.

In a third example, there is a method comprising: converting a sound signal to one or more control signals; transmitting the control signals to one or more actuators of a bone conduction device to cause the one or more actuators to deliver vibrations to a target location within a recipient’s concha, wherein none of the control signals based on the sound signal are transmitted to an actuator configured to deliver vibrations to a target location within a recipient’s ear canal.

### BRIEF DESCRIPTION OF THE DRAWINGS

Embodiments of the present invention are described herein in conjunction with the accompanying drawings, in which:

FIG. 1 illustrates a first example system that includes an apparatus worn with respect to a recipient’s outer ear.

FIG. 2 illustrates the first example system with respect to a partial cross-section view of a recipient’s ear.

FIG. 3 illustrates a second example system that includes an apparatus worn with respect to a recipient’s outer ear.

FIG. 4 illustrates the second example system with respect to a partial cross-section view of a recipient’s ear.

FIG. 5 illustrates a third example system that includes an apparatus worn with respect to a recipient’s outer ear.

FIG. 6 illustrates the third example system with respect to a partial cross-section view of a recipient’s ear.

FIG. 7 illustrates methods of making and using a pinna device.

### DETAILED DESCRIPTION

Ear-worn devices can include consumer audio devices (e.g., earbuds and headphones) and medical devices, such as hearing aids and auditory prostheses. Recently, consumer bone conduction devices have been produced that deliver vibrations to a region beside the ear to cause hearing percepts without obstructing the ear canal. In addition, bone conduction auditory devices have been developed that deliver bone conduction vibrations directly into a recipient’s ear canal. For example, US 2010/0222639, which is entitled “HEARING DEVICE HAVING A NON-OCCLUDING IN THE CANAL VIBRATING COMPONENT” and which is hereby incorporated by reference herein in its entirety for any and all purposes, describes, among other embodiments, a bone conduction hearing device having both a vibration transducer that is self-retained in an ear’s concha and a non-occluding in-the-canal vibration transducer assembly.

Disclosed examples include devices that are wearable at a recipient’s pinna. The devices can be sized and shaped to fit at a recipient’s pinna without entirely obstructing an ear canal proximate the pinna. Such an example implementation can be in contrast to typical consumer audio devices, which can be configured to be disposed at least partially within the ear canal to direct air-conducted audio signals through the ear canal to the ear drum. Devices that obstruct the ear canal can cause discomfort and impair the recipient’s ability to hear noises other than those produced by the device.

In an example, the device is provided in multiple different shapes and sizes to accommodate various pinnas. A device can be at least partially manufactured to fit a particular recipient. For instance, a 3D scan of the recipient’s outer ear can be performed and at least a portion of the device can be manufactured based on the scan.

In some implementations, disclosed devices can be configured to fit entirely or mostly within a recipient’s pinna. In some examples, no more than 10%, 20%, 30%, 40%, or 50% of the device is configured to extend outside of the pinna or outer ear in which the device is worn. In some examples, the device can include an extension that extends outside of the outer ear. The extension can extend away from a portion of the housing contained in the recipient’s outer ear. The extension can extend from the housing at a particular angle. For example, the angle can be configured such that the extension extends downward and/or forward from the recipient’s ear when the device is worn. The extension can take any of a variety of shapes and sizes. In an example, the extension is an elongate, cylindrical extension. While a cylindrical extension has been described, it should be appreciated that certain embodiments can also encompass housings/extensions of any suitable geometry. One or more of the components of the device (e.g., as described in more detail herein with respect to circuitry) can be housed in the extension. The extension can be integral with the housing and can be formed from a same material as the housing. In some implementations, at least some components (e.g., a battery) can be disposed in a behind-the-ear component coupled to the device. The connection can be made through a cable connection or via a rigid connection, among other connections. In other examples, devices can lack a behind-the-ear component or can function without a behind-the-ear component.

Disclosed devices can include circuitry for providing various features, such as stimulation and sensing. Components can be part of or connected to the circuitry, and the components can include a microphone, a sound processor, and a stimulator, among other components. In examples, the device can include a bone conduction actuator configured to deliver bone conduction vibration to the recipient to cause the recipient to experience an auditory percept. For example, the vibrations can be conducted to the recipient’s mastoid bone from a location in the recipient’s pinna (e.g., a concha thereof) in contact with a vibration transfer surface of the device.

The device can be configured to deliver bone-conduction vibrations directly to the recipient’s pinna. The device can be so configured by, for example, having a vibration transfer surface arranged on the device such that the surface is disposed within the pinna when the device is worn. The vibration transfer surface can be configured to directly contact and deliver vibrations directly to tissue of the recipient’s pinna when the device is worn. The vibration transfer surface can be coupled to a vibratory actuator, thereby configuring the actuator to deliver vibrations directly to the pinna.

The device can lack a component configured to deliver vibrations directly to a non-pinnal surface, such as the recipient’s ear canal, when the device is worn. For instance, the first tissue of the recipient to receive vibrations generated by the devices can be tissue of the pinna rather than tissue of the recipient’s ear canal. For example, the device can lack an in-canal portion that vibrates to deliver vibrations directly to the ear canal. In some examples, the device can lack a component configured to deliver vibrations to a non-pinnal surface. In some implementations, the device can be configured to directly deliver vibrations to the pinna with incidental vibrations being conducted to the ear canal via the recipient’s tissue. This can be in contrast to an alternative implementation, where a device is configured to deliver vibrations directly to the ear canal, with incidental vibrations being conducted to the pinna via the recipient’s tissue.

In some implementations, the device can lack a component that extends into the recipient’s ear canal. Thus, in contrast to apparatuses having components configured to conduct vibrations directly within the ear canal, certain implementations disclosed herein can lack such a feature. In-canal bone conduction can be unnecessary in certain circumstances, and entirely omitting an in-canal portion can make the device amenable to users that do not want a device within their ear canal.

In other implementations, the devices can include a projection configured to be inserted into the recipient’s ear canal. The projection can be configured to retain the device at the recipient’s pinna. Where the device includes an actuator configured to deliver vibrations to the recipient’s pinna, the projection may receive incidental vibrations from the actuator without the projection being configured to deliver vibrations. In some examples, the projection is arranged to resist vibration transfer or be vibrationally decoupled from the actuator. In some implementations, the device can include a projection into the ear canal that is not an in-canal bone conduction member (e.g., the projection can be a passive component lacking a vibrating actuator or the device’s vibration transfer surface is configured to be a surface other than a surface of the projection), which can make the configuration more amenable for use of the device for consumer electronics. Further, delivering vibrations via the ear canal can result in an undesirable tradeoff between comfort and vibration-transfer efficiency, where one is enhanced at the expense of the other. Certain components that encourage vibration transfer (e.g., hard components having a tight fit within an ear canal) can cause discomfort while components that encourage comfort in the ear canal (e.g., soft components) can fail to effectively transmit vibrations. Further, recipients may find vibration transfer via the ear canal to be uncomfortable.

In some implementations, the device (with or without a projection) can include a damper that resists the transfer of vibrations. In an example, the projection is or includes a damper that inhibits the transfer of vibrations to a recipient’s ear canal.

The device can be retained in the pinna based on its shape. For example, the shape can contribute to a friction fit or interference fit between the device and the structure of the pinna. In some examples, the device can be configured to be retained by slotting into a fold of a recipient’s ear. In addition or instead, the device can include a projection that extends into the recipient’s ear canal to retain the device. The projection can be a hollow tube in communication with an opening in the device to permit the ear canal to be substantially unobstructed. Further, the projection can be vibrationally-decoupled (e.g., using the damper) to permit retention while resisting vibration transfer.

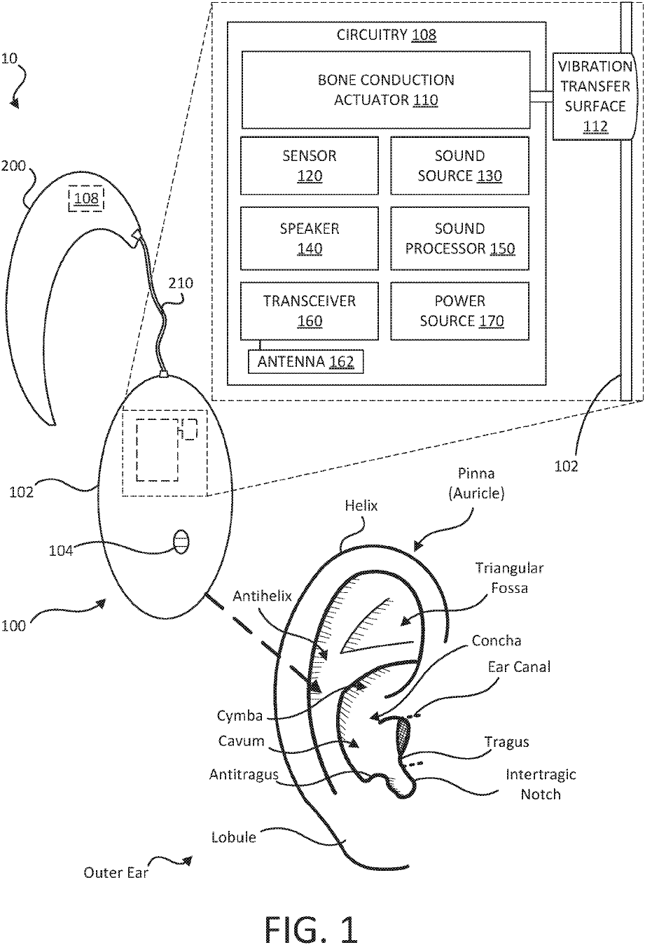

Example implementations of the devices are shown and described in FIGS. 1-6, below.

### First Example System

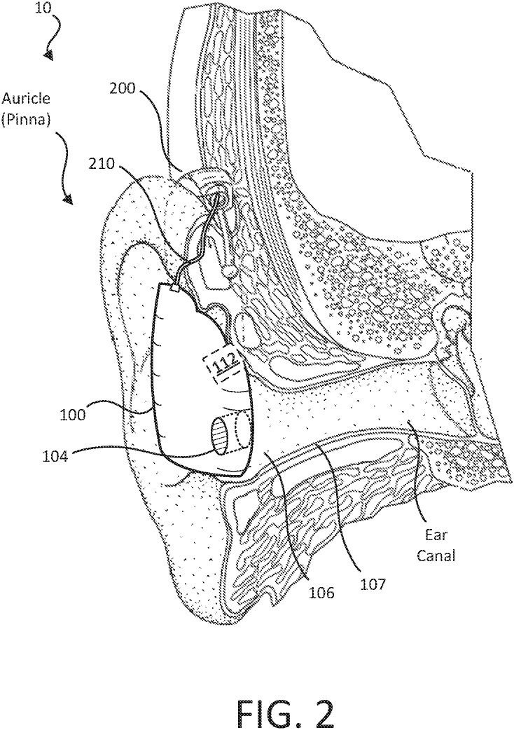

FIG. 1 illustrates a first example system 10 that includes an apparatus 100 worn with respect to a recipient’s outer ear. FIG. 2 illustrates the first example system 10 with respect to a partial cross-sectional perspective view of a recipient’s ear.

The outer ear refers to the portion of the ear that includes the pinna (also known as the “auricle”) and ear canal up to the tympanic membrane (ear drum). The ear canal is the tube running from an opening defined by the pinna to the tympanic membrane though which sound can be transmitted. The pinna is the external portion of the ear, which includes every part of the outer ear except the ear canal. Typical pinnae include multiple portions, including the helix, the antihelix, triangular fossa, concha, tragus, antitragus, intertragic notch, and lobule, among others. The concha is the typically shell-shaped indention defined by the structure of the pinna that leads to the ear canal. The concha is typically bound by the tragus and anti-helix and connects to the mastoid bone. The concha includes two primary sections: the cymba and the cavum. The cymba corresponds to the upper portion of the concha and the cavum corresponds to the lower portion. The devices described herein can be configured to fit with respect to a recipient’s outer ear.

As illustrated, the apparatus 100 can include a housing 102 with circuitry 108 disposed therein. The housing 102 can be a wearable housing configured to be worn in the recipient’s pinna, such as by being shaped to fit within the pinna. In some examples, the housing is configured to be worn entirely within the recipient’s pinna. The housing 102 can be configured to be wearably retained by its fit within the pinna. The housing 102 can be so configured by being sized or shaped to be wearably retained by its fit within the pinna. The housing 102 can also be so configured by having one or more materials or retention features to facilitate retention. As an example, the housing 102 can include a portion sized and shaped to fit within the cymba and tuck under the antihelix to facilitate retention of the housing 102. As another example, the housing 102 can include a pliable material or retention feature (e.g., a tab or hook) that grips one or more portions of the ear anatomy to retain the device relative to the ear. The housing 102 can be configured to be worn within a pinna without entirely obstructing an ear canal of the pinna, such as by defining an opening 104. In the illustrated example, the apparatus 100 of system 10 lacks a component extending into the recipient’s ear canal. In some examples the housing 102, when worn, attenuates or otherwise reduces a decibel level of ambient noise by less than approximately m decibels, where m is a value between 0 and 5 in steps of 0.1 (e.g., 0.1 dB, 0.2 dB, 0.3 dB, ..., 4.9 dB, 5 dB).

The opening 104 can be a region defined by the housing 102 and configured to permit sound to enter an ear canal proximate the pinna when the apparatus 100 is worn by the recipient. The opening 104 can take any of a variety of configurations. The opening 104 can be an absence of material extending entirely through the housing 102 from a first side of the housing (e.g., a side facing away from the ear when worn) to a second side of the housing (e.g., a side that faces the ear when worn). The opening 104 can be defined in any of a variety of ways. In the illustrated example, the opening 104 is surrounded by material of the housing 102. In other examples, the opening 104 can be partially surrounded by the housing 102. For instance, the housing 102 can be C-shaped or define a notch that corresponds to the opening 104 prevent the housing 102 from blocking the ear canal. The opening 104 can be defined at a location of the housing 102 such that when the housing 102 is worn, the opening 104 is disposed proximate the ear canal. The path of the opening 104 through the housing 102 can, but need not, be straight. The opening 104 can be completely open or be partially-covered with a grille or other structure. The opening 104 can be sized to correspond at least n% of a recipient’s ear canal (e.g., an ear canal of an average person), where n is an integer value between 0 and 300 (e.g., 1%, 2%, 3%, ..., 300%).

In the illustrated example, the apparatus 100 lacks a component configured to extend into a recipient’s ear canal when the apparatus 100 is worn. The apparatus 100 is configured to be used solely with the recipient’s pinna and not enter the ear canal.

As illustrated, the circuitry 108 can include or be connected to one or more of components from the group of: a bone conduction actuator 110, a sensor 120, a sound source 130, a speaker 140, a sound processor 150, a transceiver 160, and a power source 170, other components, or combinations thereof.

The apparatus 100 can be a bone conduction device and include the bone conduction actuator 110. The bone conduction actuator 110 can be a component configured to generate vibrations. The bone conduction actuator 110 can be configured to conduct the vibrations to a surface of a pinna (e.g., a surface of the concha of the pinna) when the apparatus 100 is worn by a recipient. The bone conduction actuator 110 can be configured to be disposed entirely within the pinna’s concha when the bone conduction apparatus 100 is worn by the recipient. The bone conduction actuator 110 can be implemented using any of a variety of different techniques to generate vibratory output. The bone conduction actuator 110 can be or include one or more piezoelectric or electro-magnetic transducers that cause a mass to vibrate. An example implementation of an actuator and associated components that can be adapted for use herein is described in US 10,477,331, which issued Nov. 12, 2019, and which is hereby incorporated by reference herein in its entirety for any and all purposes. The bone conduction actuator 110 can be any suitable actuator.

The bone conduction actuator 110 can include or be connected to a vibration transfer surface 112 configured to contact a target location to which vibrations are to be transferred. For example, the target location can be a surface of the pinna, thereby resulting in vibrations generated by the bone conduction actuator 110 being conducted from the bone conduction actuator 110 to the pinna. In an example, the first tissue of the recipient that receives the vibrations from the bone conduction actuator 110 is tissue of the recipient’s pinna. The vibration transfer surface 112 can be configured to conduct vibrations from the bone conduction actuator 110 to a point of contact corresponding to a target location within a pinna when the apparatus 100 is worn at least partially within the pinna. For example, the vibration transfer surface 112 can be so configured by being disposed at a location of the housing 102 that will be disposed proximate a desired location within the pinna when the apparatus 100 is worn at the pinna. In an example, the point of contact is a portion of the pinna that is proximate the mastoid bone. The point of contact can be a portion of the concha, such as one or both of the cymba and cavum. The vibration transfer surface 112 can be integral with the housing 102. For instance, the vibration transfer surface 112 can be a portion of the housing to which the bone conduction actuator 110 delivers vibrations for conduction to the recipient. In other examples, the vibration transfer surface 112 can be at least partially separate from the housing 102. The vibration transfer surface 112 can be configured to resist transfer of vibrations to portions of the housing 102 (e.g., is vibrationally isolated from the housing 102). For example, the vibration transfer surface 112 can be separated from the housing 102 with an air gap, a material (e.g., a flexible material such as silicone forming a gasket or other configuration), or component (e.g., a spring) to resist vibration transfer from the vibration transfer surface 112 to adjacent portions of the housing 102. In some implementations, the vibration transfer surface 112 is the sole vibration transfer surface 112 of the housing 102.

The sensor 120 can be one or more sensing components configured to measure a state and produce a signal in response. The sensor 120 can take any of a variety of forms. The apparatus 100 can be a medical device and the sensor 120 can be a medical device sensor. The apparatus 100 need not be a medical device (e.g., the apparatus 100 can be a consumer electronics device) but the sensor 120 can still sense one or more attributes of the recipient wearing the apparatus. For instance, the sensor 120 can include one or more biosensors (e.g., heart rate or blood pressure sensors), otoacoustic emission sensors, EEG (electroencephalography) sensors, galvanic skin response sensors, temperature sensors, or other sensors. In an example, the sensor includes one or more location sensors, telecoils, light sensors, touch sensors, tap sensors, accelerometers, gyroscopes, piezoelectric sensors, or other kinds of sensors. The sensor 120 can include one or more components disposed within a housing 102 of the apparatus 100 as well as devices electrically coupled to the apparatus (e.g., via wired or wireless connections). The data produced by the sensor 120 can be stored in memory of the apparatus 100 for use by the recipient or a clinician. In examples, the data produced by the sensor 120 can be used to control functions of the apparatus 100, such as the stimulation provided.

The sound source 130 can be a component configured to detect or receive sound signals and to generate electrical signals therefrom, such as signals that are representative of the detected sound signals. In some examples, the sound source 130 is one or more microphones. The sound source 130 can be disposed in or located outside of the apparatus 100 for sound input clarity. The sound source 130 can be or include a wireless data receiver configured to obtain, for example, audio data over a wireless transmission protocol, such as via an FM signal or BLUETOOTH.

The speaker 140 can be a component configured to generate audio signals using air conduction. The speaker 140 can be configured to generate audio based on signals from the sound processor 150.

The sound processor 150 can be a component configured to obtain a sound signal and take one or more actions based thereon. For instance, the sound processor 150 can be configured to obtain a sound signal (e.g., from the sound source 130) and actuate one or both of the bone conduction actuator 110 and the speaker 140 based on the sound signal. The sound processor 150 can execute sound processing and coding to convert the input signals generated by the sound source 130 into output data signals that represent stimulation signals to cause actuation of the bone conduction actuator 110 or the speaker 140 for causing the recipient to experience an auditory percept.

The transceiver 160 can be one or more components configured to wirelessly receive or transmit signals (e.g., a power signal or a data signal). In an example, a power signal can be received to charge the power source 170. In an example, a data signal is received by the transceiver 160 that causes actuation of one or both of the bone conduction actuator 110 and the speaker. Various types of signal transfer, such as electromagnetic, capacitive, and inductive transfer, can be used to usably receive or transmit the signal. The transceiver 160 can include or be electrically connected to one or more antennas 162 (e.g., in the form of a coil) for wireless transfer of power and data. In some examples, the transceiver 160 can be configured to communicate with an implanted medical device (e.g., an implanted auditory prosthesis), such as via an inductive connection. In examples, the transceiver 160 can be used to establish a communications link between the apparatus 100 and another device, such as a computer. The computer can be used to control functions of the apparatus 100.

The power source 170 can be a component configured to operationally power one or more components of the system 10. The power sources 170 can be or include one or more rechargeable batteries or capacitors. Power can be received from a source external to the system 10 and stored by the power source 170. The power can then be distributed to the other components as needed for operation.

In some examples, the system 10 can further include a behind-the-ear device 200 configured to be worn behind or on an ear. The behind-the-ear device 200 can be sized and shaped to be worn on the recipient’s ear. A cable 210 can couple the behind-the-ear device 200 to the apparatus 100. In various implementations, the behind-the-ear device 200 can include one or more of the components described above regarding the circuitry 108. For example, the power source 170 and at least a portion of the circuitry 108 can be disposed in the behind-the-ear device 200.

### Second Example System

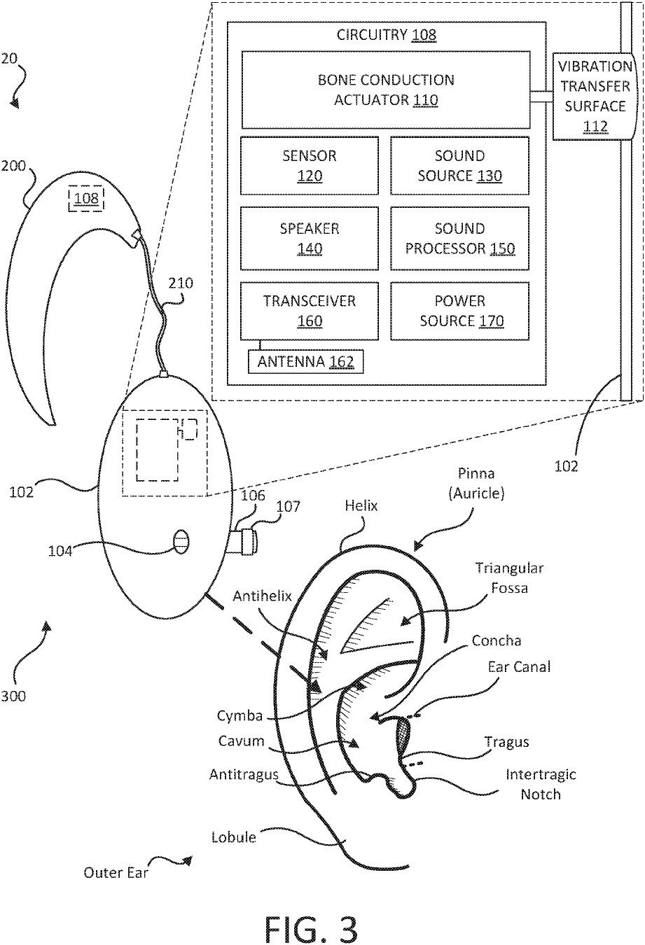

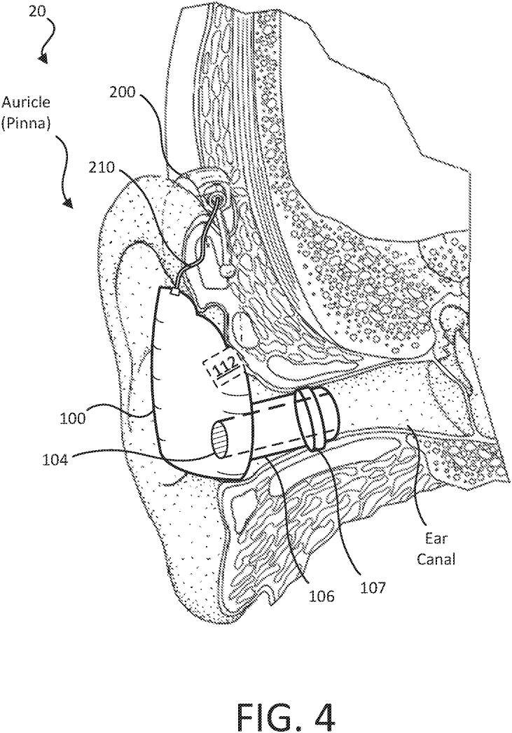

FIG. 3 illustrates a second example system 20 that includes an apparatus 300 worn with respect to a recipient’s outer ear. FIG. 4 illustrates the second example system 20 with respect to a partial cross-sectional perspective view of a recipient’s ear. The apparatus 300 and system 20 can include one or more components of the apparatus 100 and system 10. For example, as illustrated, the apparatus 300 includes a housing 102, an opening 104, circuitry 108, and a behind-the-ear device 200. The apparatus 300 further includes a projection 106 extending from the housing 102.

The projection 106 can be a component configured to be inserted into an ear canal when the apparatus 300 is worn. The projection 106 can retain the housing 102 in position relative to the ear canal. The projection 106 can be a component extending from the housing 102. The projection 106 can be a tubular structure extending from the housing 102 such that, when worn, the projection 106 aligns with the recipient’s ear canal. Where the housing 102 includes both the opening 104 and the projection 106, the projection 106 can be defined with respect to the opening 104. For example, the opening 104 can extend partially or entirely through the projection 106. The projection 106 can be or include a tubular structure coaxial with the opening 104. The projection 106 can be or include a pliable material to facilitate conformation with the ear canal anatomy the recipient. In some examples, the projection 106 can be a passive element that lacks an active transducer or vibration-delivery structure.

The projection 106 can include a collar 107 or another feature to facilitate retention of the projection 106 in the ear canal. The collar 107 can be a region of deformable material (e.g., foam or silicone) that, when inserted in the ear canal, compresses inward and exerts force radially outward against the ear canal. The force can contribute to retaining the housing 102 with respect to the ear canal and resisting removal. In some examples, one or both of the projection 106 and the collar 107 can be selected to suit the recipient’s ear canal, such as by having a suitable size or shape. In some examples, the apparatus can be provided with projections 106 or collars 107 of differing sizes from which the recipient can select to use with the apparatus 300. In some examples, the projection 106 or collar 107 can be custom made for the recipient (e.g., based on a scan or mold taken of the recipient’s ear canal).

### Third Example System

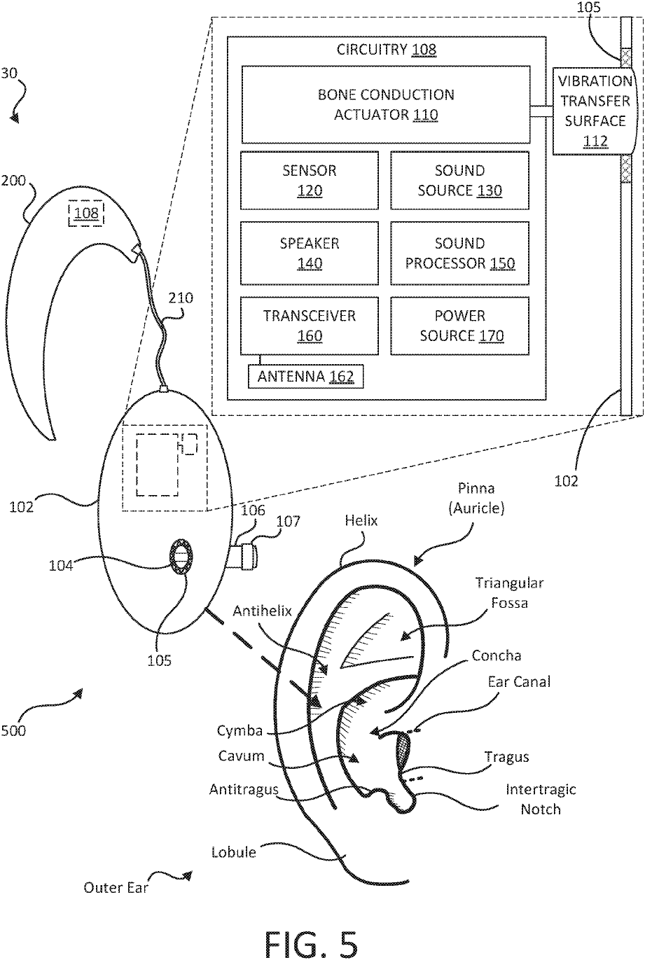

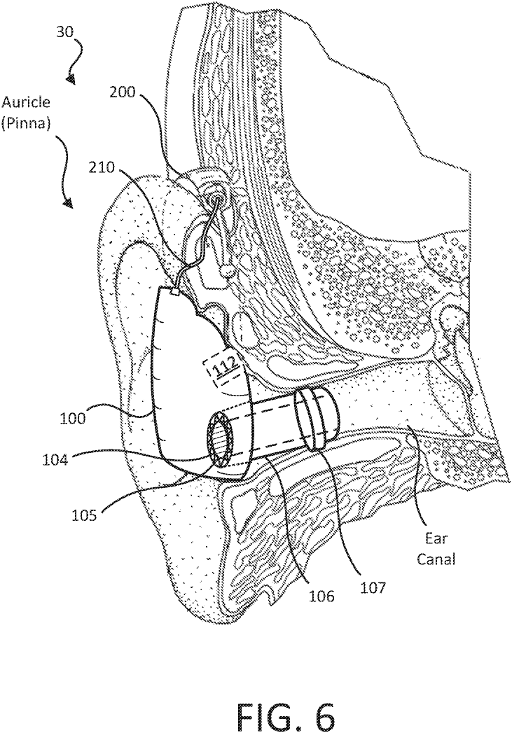

FIG. 5 illustrates a third example system 30 that includes an apparatus 500 worn with respect to a recipient’s outer ear. FIG. 6 illustrates the third example system 30 with respect to a partial cross-sectional perspective view of a recipient’s ear. The apparatus 500 and system 30 can include one or more components of the apparatus 100, apparatus 300, system 10, and system 20. For example, as illustrated, the apparatus 500 includes a housing 102, an opening 104, a projection 106, circuitry 108, and a behind-the-ear device 200. The apparatus 500 further includes one or more dampers 105.

A damper 105 can be a component configured to resist transmitting vibrations, such as can be produced by the bone conduction actuator 110. The one or more dampers 105 can disposed in any of a variety of locations. In some examples, a damper 105 can be disposed to resist the transmission of vibrations from the bone conduction actuator 110 to the sound source 130. The illustrated example includes a damper 105 disposed between the vibration transfer surface 112 and a housing 102. The illustrated example further includes a damper 105 to resist the transmission of vibrations to or through the projection 106. The damper 105 or another component can vibrationally-decouple the projection 106 from one or more other components of the apparatus 500.

The damper 105 can take any of a variety of forms. For instance, the damper 105 can be constructed to be an elastic, soft, flexible, non-rigid, gooey, and/or compliant component. In some examples, the damper 105 can be disposed such that the damper 105 extends at least partially into the ear canal when the apparatus 500 is worn. In some examples, the damper 105 can be disposed between the projection 106 and the ear canal so as to resist the transmission of vibrations from the projection 106 to the ear canal when the apparatus 500 is worn. In such an example, the damper 105 can be used to form the collar 107. The disposition of the damper 105 in contact with the recipient’s ear canal (e.g., as opposed to a rigid material) can improve comfort for the recipient. In an example, the damper 105 can be formed as a suspension system.

The damper 105 can be configured to deliberately dampen, resist, inhibit, and/or attenuate vibration transfer through the damper 105. The damper 105 can be configured to do so through its construction from particular materials. For example, the damper 105 can be constructed from polyurethane foam or silicone. The damper 105 can comprise a material having a durometer of less than about 80, 70, 60, 50, 40, 30, 20, 15, or 10. In examples, the damper 105 can be configured to attenuate the vibrations by at least 10%, at least 20%, at least 30%, at least 40%, at least 50%, at least 60%, or at least 70% (e.g., as measured via bench testing). For example, the attenuation can be measured by comparing an amount of vibrations transmitted through the damper 105 compared to an original amount of vibrations before the effect of the damper 105. In some examples, the damper 105 can be replaceable by a user.

In some examples, the damper 105 can be a component of the projection 106. In addition or instead, the projection 106 can be constructed in such a manner as to act as the damper 105. For example, the projection 106 can be constructed from a material being configured to resist transmitting vibrations (e.g., a lightweight or soft material, such as polyurethane foam or silicone). Such materials can not only resist transmission but also be more comfortable to the recipient and aid in retaining the apparatus 500. In some examples, the apparatus 500 can be arranged to resist the transmission of vibrations through the projection 106. In some examples, the projection 106 can be vibrationally isolated by being connected to the housing 102 via a damper 105. The damper 105 can be an area of material configured to resist transmission of vibrations across the damper 105. The damper 105 can include one or more suspension springs, such as can couple the projection 106 to housing 102 in a vibrationally-decoupled manner. In an example, the projection 106 can be configured as an anchor (e.g., in the form of the collar 107) connected to the housing 102 via the damper 105. In an example, the damper 105 connecting the projection 106 to the housing 102 can be in the form of a string or cable.

### Example Methods

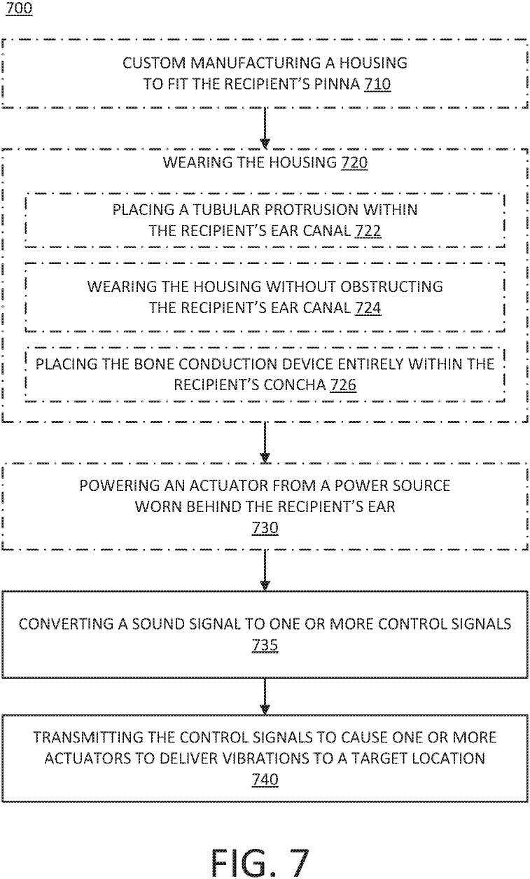

FIG. 7 illustrates an example methods 700, which can include one or more methods for making a pinna device and one or more methods for using a pinna device. The pinna device can be part of a system, such as is shown in FIGS. 1-6. The method 700 can include any of a variety of operations. As illustrated, the method 700 can include operations 710, 720, 730, 735, and 740. Several of the operations are described in relation to a housing 102, which can be the housing of a bone conduction device.

Operation 710 can include custom manufacturing a housing 102 to fit a recipient’s pinna. In an example, operation 710 can include molding some or all of the housing 102 to fit a recipient’s pinna. In an example, the operation 710 can include performing a scan (e.g., using a 3D scanning technique) of the recipient’s pinna and manufacturing the housing 102 based on the scan. In an example, the operation 710 can include forming a cymba region, a cavum region, an antitragus region, an intertragic notch region, a tragus region, a concha region, a triangular fossa region, other regions, or combinations thereof of the housing 102 based on the features of one or both of the recipient’s pinnae. Manufacturing the housing 102 to match the anatomy of the recipient’s pinna can enhance a connection between the housing 102 and the pinna, thereby contributing to strong fit and beneficial retention of the housing 102. In some examples, operation 710 can further include custom manufacturing the projection 106. For example, the operation 710 can include performing a scan of the recipient’s ear canal and manufacturing the projection 106 based thereon.

Operation 720 can include wearing the housing 102. This operation 720 can include wearing the housing 102 at a recipient’s pinna. Where the housing 102 includes one or more tabs, hooks, springs, or other features to facilitate supporting the housing 102, the operation 720 can include engaging such features to retain the housing 102 with respect to the recipient’s pinna. For example, wearing the housing 102 can include placing a tubular projection 106 of the housing 102 within a recipient’s ear canal (operation 722). The tubular projection 106 can be inserted into the recipient’s ear canal such that the weight of the housing 102 (and the components thereof) can be partially or wholly supported by the projection 106. Wearing the housing 102 can include wearing the housing 102 without the housing 102 obstructing the recipient’s ear canal (operation 724). For example, when worn, the housing 102 can be disposed such that an opening 104 defined by the housing 102 is disposed proximate the recipient’s ear canal. Wearing the housing 102 can include placing the housing 102 entirely within the recipient’s concha (operation 726). In some examples, the housing 102 can be sized and shaped to be worn entirely within the concha without substantially protruding outside of the concha.

Operation 730 can include powering an actuator 110 from a power source 170 worn behind the recipient’s ear. The actuator 110 can be a bone conduction actuator 110 of the housing 102. As described above, the apparatus 100 can include a behind-the-ear device 200 that includes circuitry 108 that can include a power source 170. The power source 170 can operationally power one or more of the components within the housing 102.

Operation 735 can include converting a sound signal to one or more control signals. The sound signal can be a representation of sound, such as may be produced by the sound source 130. The control signal can be a signal configured to cause the bone conduction actuator 110 to actuate in a particular manner. For instance, the control signal can be configured to cause the bone conduction actuator 110 to generate vibrations configured to cause the recipient to experience a hearing percept representative of the sound signal. In an example, the sound signal can be produced as output from the sound source 130, and the sound processor 150 can be used to convert the sound signal into the control signal. As another example, one or more of the techniques described in US 10,477,331, which was previously incorporated herein by reference, can be used to process the sound signal and generate the control signals.

Operation 740 can include transmitting the control signals to cause one or more actuators 110 to deliver vibrations to a target location. In an example, the target location can be a region of the recipient’s pinna, such as a region of the recipient’s concha. The vibrations can then be conducted away from the target location and cause the recipient to experience a hearing percept. In some examples, the target location is the first location of the recipient to which vibrations are directed. In at least some examples, none of the control signals based on the sound signal are transmitted to an actuator 110 configured to deliver vibrations to a target location within a recipient’s ear canal.

As should be appreciated, while particular uses of the technology have been illustrated and discussed above, the disclosed technology can be used with a variety of devices in accordance with many examples of the technology. The above discussion is not meant to suggest that the disclosed technology is only suitable for implementation within systems akin to that illustrated in the figures. In general, additional configurations can be used to practice the processes and systems herein and/or some aspects described can be excluded without departing from the processes and systems disclosed herein.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and processes to the particular aspects described. Accordingly, additional configurations can be used to practice the methods and systems herein and/or some aspects described can be excluded without departing from the methods and systems disclosed herein.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure. Further, the disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. An apparatus comprising:
a bone conduction actuator configured to conduct vibrations directly to a surface of a pinna when the apparatus is worn by a recipient,
wherein the apparatus lacks a component configured to deliver vibrations directly to a non-pinnal surface.

2. The apparatus of claim 1, wherein the bone conduction actuator is configured to be disposed entirely within the pinna’s concha when the apparatus is worn by the recipient.

3. The apparatus of claim 1, further comprising:
a wearable housing configured to be worn in the pinna,
wherein the bone conduction actuator is disposed in the wearable housing.

4. The apparatus of claim 3, further comprising:
a sound processor disposed in the wearable housing and configured to obtain a sound signal and actuate the bone conduction actuator based on the sound signal.

5. The apparatus of claim 3, wherein the wearable housing defines an opening configured to permit sound to enter an ear canal proximate the pinna when the apparatus is worn.

6. (canceled)

7. The apparatus of claim 1, further comprising:
a tubular projection configured to be inserted into an ear canal proximate the pinna,
wherein the tubular projection is configured to be vibrationally decoupled from the bone conduction actuator.

8. The apparatus of claim 1,
wherein the bone conduction actuator comprises a vibration transfer surface configured to contact a surface of the pinna and thereby conduct vibrations directly to the pinna.

9. A system comprising:
a bone conduction device having:
a bone conduction actuator; and
a single vibration transfer surface, wherein the vibration transfer surface is configured to conduct vibrations from the bone conduction actuator to a point of contact within a pinna when the bone conduction device is worn at least partially within the pinna.

10. The system of claim 9, further comprising:
a sound source;
a sound processor configured to cause the bone conduction actuator to vibrate based on sound signal obtained from the sound source; and
a power source configured to operationally power one or more components of the system.

11. The system of claim 10, further comprising:
a behind-the-ear device configured to be worn behind an ear and comprising one or more of: the sound source, the sound processor, and the power source; and
a cable coupling the behind-the-ear device to the bone conduction device.

12. The system of claim 10 , further comprising:
a housing configured to be worn entirely within a pinna; and
wherein the housing comprises: the bone conduction actuator, the vibration transfer surface, the sound source, the sound processor, and the power source.

13. The system of claim 9, wherein the bone conduction device has a housing shaped to fit within the pinna.

14. The system of claim 9, wherein the bone conduction device further comprises:
a projection configured to be inserted into an ear canal and retain the bone conduction device when the bone conduction device is worn.

15. The system of claim 9, wherein the bone conduction device has a housing configured to be retained within the pinna by its fit within the pinna.

16. A method comprising:
converting a sound signal to one or more control signals; and
transmitting the one or more control signals to one or more actuators of a bone conduction device to cause the one or more actuators to deliver vibrations to a target location within a recipient’s concha,
wherein none of the control signals based on the sound signal are transmitted to an actuator configured to deliver vibrations to a target location within a recipient’s ear canal.

17. The method of claim 16, further comprising:
custom manufacturing the bone conduction device to fit the recipient’s concha.

18. The method of claim 16, further comprising:
placing a tubular projection of the bone conduction device within the recipient’s ear canal.

19. The method of claim 16, further comprising:
placing the bone conduction device within the recipient’s concha without obstructing the recipient’s ear canal.

20. The method of claim 16, further comprising:
placing the bone conduction device entirely within the recipient’s concha; or
powering the bone conduction device from a battery worn behind the recipient’s ear.

21. An apparatus comprising:
a housing comprising circuitry and being configured to fit within a pinna without entirely obstructing an ear canal proximate the pinna; and
a tubular projection extending from the housing and being configured to be inserted into the ear canal,
wherein the tubular projection is vibrationally decoupled from the housing.

22. The apparatus of claim 21, further comprising:
wherein the housing defines an opening configured to permit sound to enter the ear canal.

23. The apparatus of claim 21, wherein the housing is configured to be retained by an interface between the housing and the pinna.

24. The apparatus of claim 21, wherein the tubular projection is coupled to the housing via one or more springs.

25. The apparatus of claim 21, wherein the circuitry comprises a sound processor; and wherein the housing comprises a bone conduction actuator configured to generate vibrations based on signals from the sound processor.

26. The apparatus of claim 21, wherein the circuitry includes circuitry of a medical device sensor.

27. The apparatus of claim 21, wherein the housing is configured to fit entirely within a concha of the pinna.

28. The apparatus of claim 21, wherein the circuitry comprises a sound processor; and wherein the housing comprises a speaker configured to generate audio based on signals from the sound processor.

29. The apparatus of claim 21, wherein the housing comprises:
a sound source; and
a power source configured to operationally power one or more components of the apparatus,
wherein the circuitry is a sound processor configured to cause a bone conduction actuator to vibrate based on a sound signal obtained from the sound source.

30. The apparatus of claim 21, wherein the housing is configured to be retained by its fit within the pinna.
